(19) United States
(12) Patent Application Publication
(10) Pub. No.: US 2023/0309509 A1
(43) Pub. Date: Oct. 5, 2023

(54) SMART INTEGRATED SYSTEM FOR MONITORING AND FEEDING PETS

(71) Applicant: PES UNIVERSITY, Bengaluru (IN)

(72) Inventors: PALLAVI GOPINATH, Bengaluru (IN); PRARTHANA PADMANABH BHAT, Bengaluru (IN); VISMAYA BANGALORE NAGENDRA, Bengaluru (IN)

(21) Appl. No.: 18/129,179

(22) Filed: Mar. 31, 2023

(30) Foreign Application Priority Data
Mar. 31, 2022 (IN) 202241019840

(51) Int. Cl. A01K 5/02; A01K 29/00; A01K 11/00; A01K 27/00

(52) U.S. Cl. CPC A01K 5/0233; A01K 29/005; A01K 11/006; A01K 27/001

(57) ABSTRACT

A method for monitoring and feeding pets includes identifying pre-defined feeding time for a pet of one or more pets and playing audio for a specific pet based on the identified feeding time. The method also includes of receiving a data signal indicating real-time coordinates of the pet to determine a real-time distance of the pet from a pet feeder. The method also includes determining an amount of pet food to be fed to the pet and calculating an amount of pet food to be dispensed to the pet based on the determined amount of pet food and/or a current amount of pet food in a pet feeding container. Additionally, the method also includes of controlling a motor to move flaps of the pet feeder to dispense the calculated amount of pet food into the pet feeding container.

### BACKGROUND

The present disclosure is U.S. Non-Provisional application that claims the benefit of Indian Patent Application No. 202241019840, filed Mar. 31, 2022; all of which is incorporated herein by reference.

### TECHNICAL FIELD

The present disclosure relates to the field of pet monitoring, and in particular, relates to a smart integrated system for monitoring and feeding pets.

### DESCRIPTION OF THE RELATED ART

In the contemporary era, people have become increasingly preoccupied with their professional and personal commitments, and hence are not able to spend enough time with their pets. It has been observed that this trend has adversely impacted the mental and physical well-being of their pets. For instance, if a pet owner does not spend enough time with their pets, then it can affect the mental well-being of the pets, such as making them lonely, bored, stressed, and short-tempered. It has been observed that such mental well-being leads to behavioral issues in the pets, such as attacking people including the owners, or causing damage to property and goods. Additionally, if a pet owner does not feed the pet consistently, then it can lead to pets overeating or not getting enough food, resulting in the pets becoming overweight or underweight, respectively.

To mitigate the impacts of such issues, the pet owners utilize one or more pet monitoring and feeding systems and devices. Such known systems assist the pet owners by feeding a specific amount of food to their pet at set intervals and/or by providing live video feeds or photos of the pets to monitor the pet through a connected user device, such as a mobile phone. However, such monitoring technologies are more suitable for remote monitoring by the user rather than automatic monitoring, as the pet owner must view the video feeds or photos on time to take corrective action if required. Further, there might be instances when the pet had not completely eaten the dispensed food at the previously scheduled time, but the feeding device dispenses the set amount of food in a pet feeding container again at the next scheduled time. Apart from spillage of food from the pet feeding container and/or wastage of pet food, such a scenario can lead to overeating by the pet, impacting the pets' health. Such scenarios are very critical since the pet owner is not around, as it can lead to further deterioration of the pet's health due to unavailable care, and hygiene issues for both the pet and the owner.

Additionally, such pet monitoring and feeding devices fail to perform accurately, especially when there are multiple pets present in an establishment. For example, the monitoring camera may be focused on one pet and the other pets are not monitored. Similarly, the feeding device fails to determine how much food should be dispensed for each pet of a plurality of pets present in the establishment. The systems fails to stop one pet from eating food of other, resulting in overeating of one pet and undereating of the other pet. Some of these issues are partially addressed by the existing systems described below:

U.S. Pat. No. 2014,0345,533 A1 discloses a sensor-controlled food and water bowl for pets. The patent '533 discloses a collar for a pet having a sensor for selectively operating one or more bowls allocated to the pet. Such a system of the patent '533 restricts one pet from eating food from other pet's bowl. However, the patent '533 fails to address the issue of spillage or wastage of food when the pet did not completely eat the food in the previously scheduled time. Also, the patent '533 does not address the issue of determining the amount of food to be dispensed for each pet when there are more than one pets in the establishment.

U.S. Pat. No. 2020,0236,901 A1 discloses animal interaction devices, systems, and methods. The patent '901 discloses measuring a dog's energy expenditure and or movement, and providing signals to the dog to engage in activities or games to earn food. The patent '901 also discloses determining the amount of food intake level for the dog based on the dog's activity level, age, weight, body mass, and other health information. However, the patent '901 discloses determining an amount of food intake for the pet, it fails to address the issue of dispensing the determined amount of food corresponding to a specific pet when the establishment has one or more pets. Also, the patent '533 fails to address the issue of spillage or wastage of food when the pet did not completely eat the food in the previously scheduled time.

Therefore, there is a need for an improved smart integrated system for monitoring and feeding pets that overcomes the drawbacks of the prior arts.

### BRIEF SUMMARY

One or more embodiments are directed to a pet monitoring and feeding system and method of the same.

An embodiment of the present disclosure discloses a system for monitoring and feeding pets. The system includes a timer module to identify a pre-defined feeding time for a pet of one or more pets in a geofence. The pre-defined feeding time may be automatically set by the AI model or manually set by a user. The AI model may use parameters, such a health parameters of the pet, type of pet, environmental conditions, and availability of food to determine feeding time of a pet. In some embodiments, the system includes an audio module to play an audio associated with the pet based on the identified feeding time. Each of the one or more pets may be pre-trained to arrive for feeding in furtherance to playing a corresponding audio. In some embodiments, the system includes a receiving module to receive a data signal indicating real-time coordinates of the pet from a pet collar of the pet whose audio is played.

In some embodiments, the system includes a proximity module to determine a real-time distance of the pet from a pet feeder based on strength the received data signal. In order to determine the real-time distance of the pet, the proximity module compares the received real-time coordinates with the coordinates of the pet feeder. In some embodiments, the system includes an analyzing module to determine the amount of pet food to be fed to the pet by employing the Artificial Intelligence (AI) model. Further, the analyzing module calculates the amount of pet food to be dispensed to the pet based on the determined amount of pet food, a current amount of pet food in a pet feeding container, or a combination thereof. The analyzing module calculates the current amount of pet food in the pet feeding container via a weight sensor to measure a weight of the pet food in the pet feeding container, or a camera module to measure a volume of the pet food in the pet feeding container by employing an image processing technique, or a combination thereof.

In some embodiments, the system includes a dispensing module to control a motor to move one or more flaps of the pet feeder to dispense the calculated amount of pet food into the pet feeding container. The calculated amount of pet food may be dispensed into the pet feeding container when the determined real-time distance is less than a pre-defined threshold distance. In some embodiments, the pet feeder includes an overhead storage container to store the pet food, wherein the storage container has one or more partitions to store one or more types of pet food associated with one or more pets. The overhead storage container further includes one or more lids for air-tight sealing of the one or more partitions via a slide lock mechanism controllable by a lid motor.

Further, the pet feeder includes a funnel to direct a smooth flow of the pet food from the overhead storage container to the pet feeding container. The funnel further includes the motor to rotate based on a control signal from the dispensing module and the one or more flaps coupled to the motor, such that the rotation of the motor moves the one or more flaps to control the flow of the pet food into the pet feeding container. The pet feeding container is movable across at least a vertical axis for height adjustment based on a height of the pet.

In some embodiments, the pet collar includes a housing that houses one or more sensors including a thermistor to measure the body temperature of the pet, an accelerometer to monitor one or more activities of the pet, a Global Positioning System (GPS) to determine the real-time coordinates of the pet, other health parameter reading sensors, or a combination thereof. The housing also houses a microprocessor to calculate a physical state of the pet and/or a mental state of the pet based on the measured body temperature and monitored one or more activities of the pet. The physical state is associated with a high temperature of the pet and to determine the high temperature associated with the pet, the microprocessor compares the measured body temperature of the pet with a threshold temperature. Similarly, data collected from other health parameter reading sensors can be correlated to determine physical or mental health condition of the pet. Further, the mental state of the pet is associated with anxiety, depression, loneliness, anger, or a combination thereof. In an embodiment, the system may use the programmed instruction embedded with the microprocessor or use the AI model running at the microcontroller that uses one or more activities and health parameter to determine if the pet is mentally unwell. In some embodiments, the microprocessor determines a potential therapy for the mental state of the pet and provides the determined potential therapy to the pet owner in form of a notification, which can be displayed on the pet collar or the pet feeder or sent to the portable device of the pet owner.

In some embodiments, the housing houses a Global System for Mobile Communication (GSM) module to send a notification to a user (also referred to as the pet owner) and/or an assigned veterinarian based on the calculated physical state, the mental state, or a combination thereof. Furthermore, the housing houses a rechargeable power source to supply power to the one or more sensors, the microcontroller, the GSM module, or a combination thereof.

In some embodiments, the pet collar can be in form of a belt having a housing for holding electronic circuits and a pair of straps attached at the opposite sides of the housing. Each of the strap is coupled to the housing at one end and includes an electromechanical coupler at other end. When the two straps are attached, it create a full circuit and holds the housing. The pair of straps are made up of a breathable material. Further, the electromechanical couplers are powered by the rechargeable power source. As a result, when the electromechanical couplers are uncoupled, an electrical signal is provided to the GSM module that sends a notification to the user if the pet is out of the geofence. The notification may indicate that the pet collar is removed.

An embodiment of the present disclosure discloses a method for monitoring and feeding pets. The method includes the steps of identifying a pre-defined feeding time for a pet of one or more pets in a geofence. In some embodiments, the method includes the steps of playing an audio for a specific pet based on the identified feeding time. Each of the one or more pets may be pre-trained to arrive for feeding in furtherance to playing a corresponding audio. In some embodiments, the method includes the steps of receiving a data signal indicating real-time coordinates of the pet from a pet collar of the pet whose audio is played. In some embodiments, the method includes the steps of determining a real-time distance of the pet from a pet feeder based on the received data signal. To determine the real-time distance of the pet, the method includes the steps of comparing the received real-time coordinates with the coordinates of the pet feeder.

In some embodiments, the method includes the steps of determining an amount of pet food to be fed to the pet by employing an Artificial Intelligence (AI) model. In some embodiments, the method includes the steps of calculating an amount of pet food to be dispensed to the pet based on the determined amount of pet food, a current amount of pet food in a pet feeding container, or a combination thereof. The current amount of pet food in the pet feeding container may be calculated via a weight sensor to measure a weight of the pet food in the pet feeding container, or a camera module to measure a volume of the pet food in the pet feeding container by employing an image processing technique, or a combination thereof. In some embodiments, the method includes the steps of controlling a motor to move one or more flaps of the pet feeder to dispense the calculated amount of pet food into the pet feeding container. The calculated amount of pet food may be dispensed into the pet feeding container when the determined real-time distance is less than a pre-defined threshold distance.

In some embodiments, the method includes the steps of sending a corresponding notification to the user when the pet collar is removed from the pet and the pet is out of the geofence. In some embodiments, the method includes the steps of measuring the body temperature and other health parameter of the pet and comparing the measured body temperature and other health parameter with corresponding acceptable range to determine a physical state of the pet. Further, the method includes the steps of sending a corresponding notification to a user and/or an assigned veterinarian based on the determined physical state of the pet.

In some embodiments, the method includes the steps of monitoring one or more activities of the pet and employing the AI model over the one or more activities to determine a mental state of the pet indicating that the pet is mentally unwell. Further, the method includes the steps of sending a corresponding notification to the user and/or the assigned veterinarian based on the determined mental state of the pet. In some embodiments, the method includes the steps of determining a potential therapy for the mental state of the pet and providing the determine potential therapy to the user in the sent notification.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGURES and examples are not meant to limit the scope of the present subject matter to a single embodiment, but other embodiments are possible by way of interchange of some or all of the described or illustrated elements and, further, wherein:

FIG. 1 illustrates an exemplary environment of a system for monitoring and feeding pets, in accordance with an embodiment of the present disclosure;

FIG. 2 illustrates a block diagram of the system for monitoring and feeding pets, in accordance with an embodiment of the present disclosure;

FIG. 3A illustrates an exploded view of a pet feeder, in accordance with an embodiment of the present disclosure;

FIG. 3B illustrates various views of the pet feeder, in accordance with an embodiment of the present disclosure;

FIG. 4A illustrates an exemplary block diagram of a pet collar, in accordance with an embodiment of the present disclosure;

FIG. 4B illustrates an exploded view of the pet collar, in accordance with an embodiment of the present disclosure;

FIG. 4C illustrates various views of the pet collar, in accordance with an embodiment of the present disclosure;

FIGS. 5A-5D illustrate one or more exemplary interfaces of a user device, in accordance with various embodiments of the present disclosure;

FIG. 6 illustrates an exemplary operation of the system for monitoring and feeding pets, in accordance with an embodiment of the present disclosure;

FIG. 7 illustrates a flow chart of a method for monitoring and feeding pets, in accordance with an embodiment of the present disclosure; and

FIG. 8 illustrates an exemplary computer system in which or with which embodiment of the present disclosure may be utilized.

Other features of embodiments of the present disclosure will be apparent from accompanying drawings and detailed description that follows.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to these specific details. In other instances, structures and devices are shown in block diagram form only in order to avoid obscuring the present technology.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Embodiments described herein may be discussed in the general context of computer-executable instructions residing on some form of computer-readable storage media, such as program modules, executed by one or more computers or other devices. By way of example, and not limitation, computer-readable storage media may include non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, the flowchart and block diagrams in the Figures illustrate the architecture, functionality, and operation of possible implementations of apparatus (systems), methods, and computer program products according to various implementations of the present disclosure. Each block in the flowchart and/or block diagrams, and combinations of blocks in the flowchart and/or block diagrams, may represent a module, segment, or portion of code, which includes one or more executable computer program instructions for implementing the specified logical function(s)/act(s). These computer program instructions may be provided to a processor of a general-purpose computer, special-purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of order noted in the figures. For example, two blocks shown in succession may, in fact, be executed substantially concurrently, or the blocks may sometimes be executed in the reverse order, depending upon the functionality involved.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system and a method for monitoring and feeding pets. The system includes identifying a pre-defined feeding time for a pet of one or more pets in a geofence and playing an audio for a specific pet of the one or more pets based on the identified feeding time. Each of the one or more pets are pre-trained to arrive for feeding in furtherance to playing a corresponding audio. Further, the system includes receiving a data signal indicating real-time coordinates of the pet from a pet collar of the pet whose audio is played. The system also includes determining a real-time distance of the pet from a pet feeder based on the received data signal and determining an amount of pet food to be fed to the pet by employing an Artificial Intelligence (AI) model. Additionally, the system includes calculating an amount of pet food to be dispensed to the pet based on the determined amount of pet food and/or a current amount of pet food in a pet feeding container and controlling a motor to move one or more flaps of the pet feeder to dispense the calculated amount of pet food into the pet feeding container when the determined real-time distance is less than a pre-defined threshold distance.

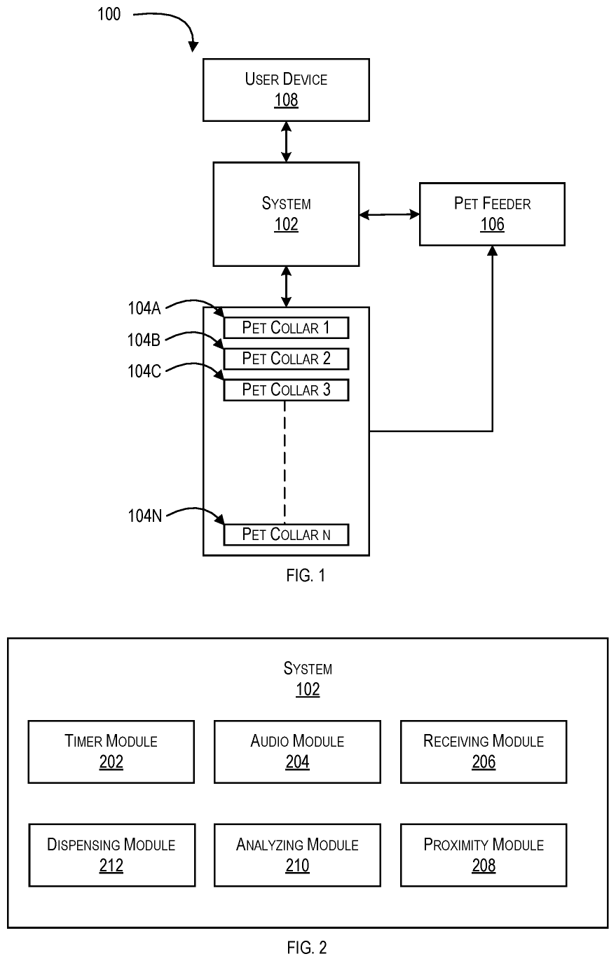

FIG. 1 illustrates an exemplary environment 100 of a system 102 for monitoring and feeding pets, in accordance with an embodiment of the present disclosure. The environment 100 may include the system 102, one or more pet collars 104A, 104B, . . . , 104N, a pet feeder 106, and a user device 108. In one embodiment, the system 102 may be implemented on a server, such as a cloud server. In another embodiment, the system 102 may be implemented on an electronic device, such as a mobile phone, a computer, and a tablet. In yet another embodiment, the system 102 may be implemented on the pet feeder 106, without departing from the scope of the disclosure. The system 102 may utilize a wireless technology to enable communication between the three components such as Bluetooth, Wi-Fi, GSM, ZigBee, RFID, and infrared. The use of wireless technology provides flexibility and ease of communication between the components. In some embodiments, each of the one or more pet collars 104A, 104B, . . . , 104N (hereinafter termed as pet collars 104) may be associated with a pet from one or more pets. In an embodiment, the one or more component of the system 102 may be part of the pet feeder 106. Further, the pet collar 104 may monitor the pet's health vitals (e.g. body temperature) along with real-time GPS coordinates for health, activity, and location tracking of the pet. Such health vitals and activity of the pet may be processed to determine the physical and mental state of the pet that may be provided to the user device 108 associated with the user. In some embodiments, the user may be the pet owner or an assigned veterinarian. In some embodiments, the pet feeder 106 may automatically dispense the food in a pet feeding container based on the pet's feeding schedule which may be setup automatically or by the user. In order to dispense the food in the pet feeding container, the pet feeder 106 may calculate an amount of pet food to be dispensed to a particular pet based on a pre-defined amount of pet food that the particular pet should intake and the pet food available in the pet feeding container.

Accordingly, the system 102 provides a convenient and automated way to feed pets, eliminating the need for pet owners to manually feed their pets. The system 102 also provides pet owners with valuable data about their pet's behavior, including their activity level and feeding habits, which can help in monitoring their pet's health. Overall, the system 102 provides a comprehensive solution for pet owners to manage their pet's feeding and activity needs, while also providing valuable data to help monitor their pet's health.

FIG. 2 illustrates a block diagram of the system 102 for monitoring and feeding pets, in accordance with an embodiment of the present disclosure. In an embodiment of the present disclosure, the system 102 may include a timer module 202, an audio module 204, a receiving module 206, a proximity module 208, an analyzing module 210, and a dispensing module 212. In some embodiments, the timer module 202 may identify a pre-defined feeding time for a pet of one or more pets in a geofence of an establishment. The establishment may, without any limitation, include a home, an office, a farm, a zoo, and a wildlife preservation sanctuary. In one embodiment, the pre-defined feeding time may be automatically set by an Artificial Intelligence (AI) model based on the pet's structure and health conditions. The AI model may use parameters, such a health parameters of the pet, type of pet, environmental conditions, and availability of food to determine feeding time of a pet. In another embodiment, the pre-defined feeding time may be manually set by the user via the user device 108.

In an embodiment of the present disclosure, the audio module 204 may play an audio for a specific pet of the one or more pets based on the identified feeding time. It may be noted that each of the one or more pets may be pre-trained to arrive for feeding when the audio corresponding to the pet is played. Accordingly, such audio may include various sounds, tones, or a recorded message to alert the corresponding pet about the feeding time, such that the pet may arrive at the pet feeder upon listening to the corresponding audio. For example, if the feeding time for a dog is set to be at 9:00 AM every day, the timer module 202 may instruct the audio module 204 to play audio for which the dog has been pre-trained at 9:00 AM, such as the playing of the audio may instruct the dog to arrive at the pet feeder 106 for feeding. In an embodiment, the pet feeder may include any or combination of a communication interface or data transfer interface, which can be used to download and store audio associated with a pet.

In an embodiment of the present disclosure, the receiving module 206 may receive a data signal indicating real-time coordinates of the pet from the pet collar 104 of the pet whose audio is played. Such data signal may be received through a wireless communication network between the pet collar 104 and the pet feeder 106. The real-time coordinates information may be used to track the pet's movements and ensure that it is within a designated area, zone, or geofence.

In an embodiment of the present disclosure, the proximity module 208 may determine a real-time distance of the pet from the pet feeder 106 based on the received data signal from the receiving module 206. In order to determine the real-time distance of the pet from the pet feeder 106, the proximity module 208 may compare the received real-time coordinates with the coordinates of the pet feeder 106. The real-time distance may be used to determine if the pet is within a pre-defined range of the pet feeder 106, such that the food may only be dispensed when the pet comes within the pre-defined range. Such dispensing, when the pet is within the pre-defined range, increases the chances of pet food being eaten by the pet for which it is dispensed. As a result, the issue of overeating by other pets and undereating of the intended pet is reduced.

In an embodiment of the present disclosure, the analyzing module 210 determines an amount of pet food to be fed to the pet by employing an AI model. In some embodiments, the analyzing module 210 may determine the amount of pet food to be fed to the pet based on the size and health conditions of the pet. In other embodiments, the analyzing module 210 may determine the amount of pet food to be fed to the pet based on the amount that would have been decided by the assigned veterinarian of the pet. Further, the analyzing module 210 may calculate an amount of pet food to be dispensed to the pet. The amount of pet food to be dispensed to the pet may be determined based on the determined amount of pet food and a current amount of pet food in a pet feeding container. In one embodiment, the analyzing module 210 may calculate the current amount of pet food in the pet feeding container via a weight sensor that may measure a weight of the pet food in the pet feeding container. In one embodiment, the analyzing module 210 may calculate the current amount of pet food in the pet feeding container via a camera module that may measure a volume of the pet food in the pet feeding container by employing an image processing technique.

In an embodiment of the present disclosure, the dispensing module 212 dispenses the calculated amount of pet food into the pet feeding container. The calculated amount of pet food may be dispensed into the pet feeding container when the determined real-time distance is less than a pre-defined threshold distance that may be automatically decided via the AI model or may be fed by the user via the user device 108. In order to dispense the calculated amount of pet food, the dispensing module 212 may send a control signal to the pet feeder 106 to control a motor to move one or more flaps of the pet feeder 106, such that the calculated amount of pet food may be dropped into the pet feeding container. The dispensing of the pet food from the pet feeder 106 has been discussed in detail in the following paragraphs.

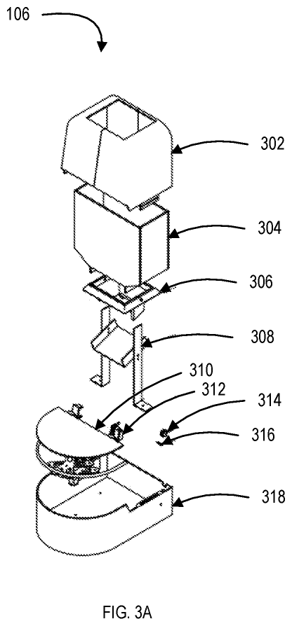

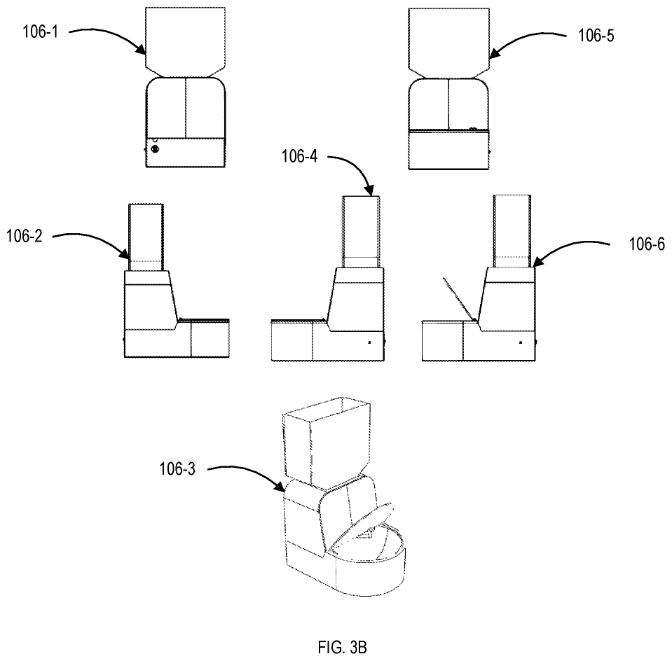

FIG. 3A illustrates an exploded view of the pet feeder 106, in accordance with an embodiment of the present disclosure. FIG. 3B illustrates various views of the pet feeder 106, in accordance with an embodiment of the present disclosure. Specifically, FIG. 3B illustrates various views of the pet feeder 106 such as a top view shown by 106-1, a right side view shown by 106-2, a perspective view shown by 106-3, a left side view shown by 106-4, a bottom view shown by 106-5, and a left side view with the open lid shown by 106-6. For the sake of brevity of explanation, FIGS. 3A and 3B have been explained together. In an embodiment of the present disclosure, the ped feeder 106 may include an upper body 302, an overhead storage container 304, a funnel 306, a bracket 308, a lid 310, a lid motor 312, a switch 314, a Light Emitting Diode (LED) 316, and a pet feeding container 318.

In some embodiments, the overhead storage container 304 may store the pet food to be dispensed for feeding the one or more pets in the establishment. The overhead storage container 304 may be covered by the upper body 302 of the pet feeder 106. In some embodiments, the overhead storage container 304 may have one or more partitions to store one or more types of pet food associated with one or more pets. Such one or more partitions may be covered by one or more lids for air-tight sealing of the one or more partitions via a slide lock mechanism. The slide lock mechanism may be controllable by the lid motor 312. Such air-tight sealing prevents air and moisture from entering the overhead storage container 304, thereby protecting the pet food from becoming stale due to one or more reasons, such as oxidation. In some embodiments, the overhead storage container 304 may be transparent and may have an aesthetic body made of Fibre Reinforced Polymers (FRP) to provide durability and strength. In some embodiments, the pet feeding container 318 may be movable across a vertical axis for height adjustment based on a height of the pet. For such instance, the pet feeder 106 may detect the height of the pet such as via a camera or an Infrared sensor, to move the per feeding container 318 up or down using a separate motor in tandem with a rack and pinion gear (not shown here).

In some embodiments, the funnel 306 and the brackets 308 may direct a smooth flow of the pet food from the overhead storage container to the pet feeding container 318. In order to dispense the food into the pet feeding container 318, a motor and one or more flaps may be installed in the funnel 306, such that the motor may rotate based on the control signal from the dispensing module 212 to move the one or more flaps for controlling the flow of the pet food into the pet feeding container 318. In some embodiments, the funnel 306 may be made up of PLA plastic and may be connected to the overhead storage container 304 through one or more mounts made of PLA plastic that may facilitate easy mounting of the motor. In some embodiments, the pet feeder 106 may include a load cell and/or a strain gauge to calculate a weight of the pet food in the pet feeding container 318, such that only the required amount of food, as mentioned in the previous paragraphs, is dispensed into the pet feeding container 318 and the pet feeding container 318 is not overfilled to further avoid spillage or wastage of the pet food.

In some embodiments, the pet feeding container 318 may be covered by the lid 310. Such lid 310 may be installed with a sensor to sense the pet collar 104 to differentiate between a pet that the food is intended from one or more other pets in the establishment. Based on the sensing from the sensor, the lid motor 312 may open the lid 310 only when the intended pet is near the pet feeding container 318 and may close the lid 310 when other pets are near the pet feeding container 318. As a result, the pet food dispensed for a specific pet is eaten by that pet only and not by other pets in the establishment. In some embodiments, the switch 314 may be utilized to turn ON or turn OFF the pet feeder 106 and the LED 316 may indicate if the pet feeder 106 is turned ON or turned OFF. Additionally, the pet feeder 106 may include a DC jack to ensure a steady power source to the pet feeder 106. In some embodiments, the pet feeding container 318 may be made of stainless steel.

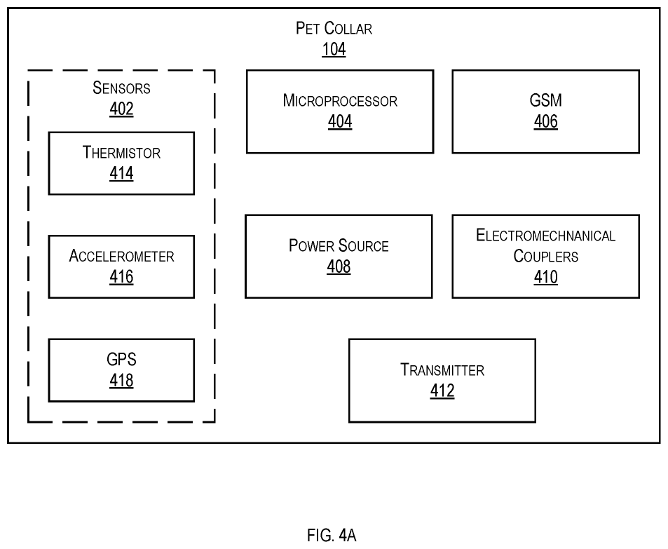

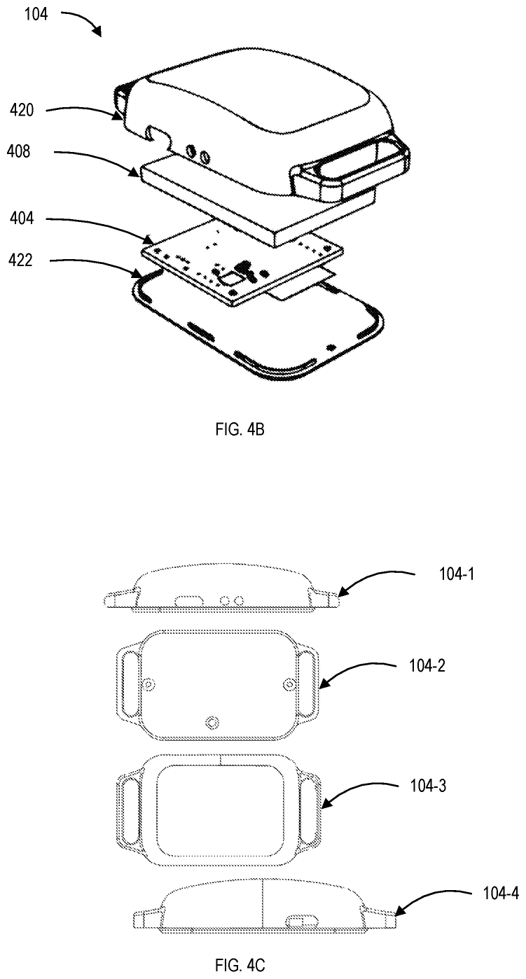

FIG. 4A illustrates an exemplary block diagram of the pet collar 104 in accordance with an embodiment of the present disclosure, in accordance with an embodiment of the present disclosure. FIG. 4B illustrates an exploded view of the pet collar 104, in accordance with an embodiment of the present disclosure, in accordance with an embodiment of the present disclosure. FIG. 4C illustrates various views of the pet collar 104, in accordance with an embodiment of the present disclosure. Specifically, FIG. 4C illustrates a left side view of the pet collar 104-1, a bottom view of the pet collar 104-2, a top view of the pet collar 104-3, and a right side view of the pet collar 104-4. For the sake of brevity of explanation, FIGS. 4A-4C have been explained together.

In an embodiment of the present disclosure, as shown in FIG. 4A, the pet collar 104 may include one or more sensors 402, a microprocessor 404, a Global System for Mobile Communication (GSM) module 406, a power source 408, a pair of electromechanical couplers 410, and a transmitter 412. Further, the one or more sensors may, without any limitation, include a thermistor 414, an accelerometer 416, and a Global Positioning System (GPS) 418. In some embodiments, as shown in FIG. 4B, the one or more components and electronic circuits of the pet collar 104 may be housed inside a housing made of an upper housing 420 and a lower housing 422. It may be noted that the power source 408 may be a rechargeable power source 408 and may supply power to one or more components, as mentioned above, of the pet collar 104. The power source 408 may also be one or more replaceable battery. The transmitter 412 of the pet collar 104 may allow a wireless connection, as mentioned in previous paragraphs, of the pet collar 104 with the pet feeder 106 and/or the system 102.

In an embodiment of the present disclosure, the thermistor 414 may measure the body temperature of the pet. The accelerometer 416 may monitor one or more activities of the pet. The Global Positioning System (GPS) 418 may determine the real-time coordinates of the pet. Such determined real-time GPS coordinates of the pet may be provided to the system 102 to determine real-time distance of the pet from the pet feeder 106, as elaborated in the previous paragraphs. The pet collar 104 may also include short range wireless communication interfaces, such as Bluetooth, and Near Field Communication (NFC).

In some embodiments, the pet collar 104 includes the microprocessor 404 that may calculate a physical state such as a high temperature, of the pet based on the measured body temperature of the pet. In order to calculate the physical state, the microprocessor 404 may compare the measured body temperature of the pet with a threshold temperature. Such threshold temperature may be pre-defined by the assigned veterinarian of the pet. In an embodiment of the present disclosure, the microprocessor 404 may send a notification to the user or the assigned veterinarian about the determined high temperature via the GSM module 406.

In some embodiments, the microprocessor 404 may calculate a mental state of the pet based on the monitored one or more activities of the pet. In some embodiments, the mental state of the pet may, without any limitation, include anxiety, depression, loneliness, and anger. Further, the microprocessor 404 may employ the AI model that uses the one or more activities to determine if the pet is mentally unwell. Such an AI model may be trained using one or more known activities of the pet associated with one or more mental illnesses, such as a dog lying on the back for too long related to the dog being lonely, excessive barking of the dog is related to anger, anxiety or fear, and excessive flapping of wings of a bird is related to fear. In some embodiments, the AI model may also be trained with one or more therapies for the one or more mental states of the pet, such as taking a dog for a walk if it has anxiety issues, feeding specific berries to birds when fear is detected, or giving certain medications for one or more mental illness. Accordingly, the microprocessor 404 may also determine a potential therapy for the determined mental state of the pet using such AI models to send the determined potential therapy in the sent notification.

In some embodiments, the pet collar 104 may include a pair of straps that may each be coupled to the housing and the electromechanical couplers 410 at either end to secure the housing on the pet. In some embodiments, the pair of straps may be made of a breathable material that allows air circulation through the pet collar 104 to prevent heating and skin irritation since the pets may become uncomfortable and/or agitated if the collar traps heat and moisture against their skin. Thus, the pair of straps ensure the comfort and safety of the pets. In some embodiments, the electromechanical couplers 410 may be powered by the rechargeable power source 408, such that when the electromechanical couplers 410 are uncoupled, an electrical signal may be provided to the GSM module 406 to send a notification to the user indicating that the pet collar 104 is removed. In an embodiment, the notification may only be sent if the pet is out of the geofence, as pre-defined by the user.

In some embodiments, the pet collar 104 may also include a display screen to display one or more real-time insights monitored for the pet, the name of the pet, and contact details of the pet owners for emergencies. Accordingly, the pet collar 104 monitors the day-to-day activities of the pet and provides non-invasive real-time body temperature measurements, which can give the veterinarian a record of the pet's health, history of diagnosis, vaccination management, or the like. Further, as elaborated above, the pet collar 104 may enable a remote health monitoring of the pet, and the data recorded during the monitoring may be stored and used for future analysis and/or diagnosis. Furthermore, the pet collar 104 facilitates the user in monitoring the physical and mental health of their pets remotely, which allows early detection and treatment of any health issues.

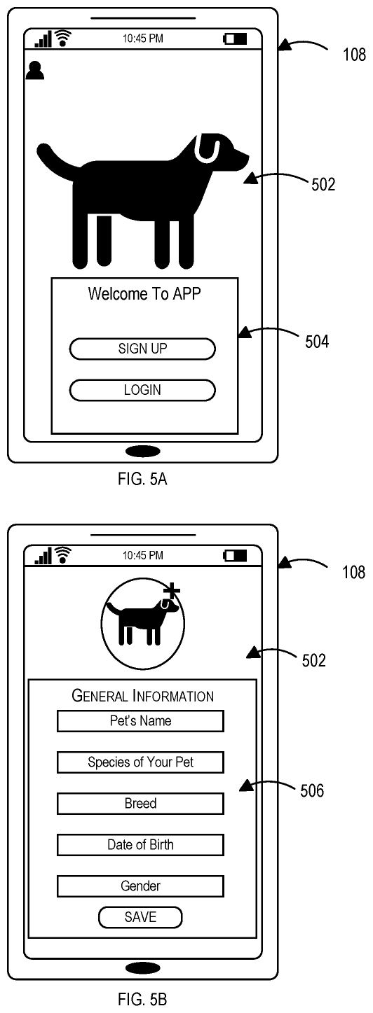

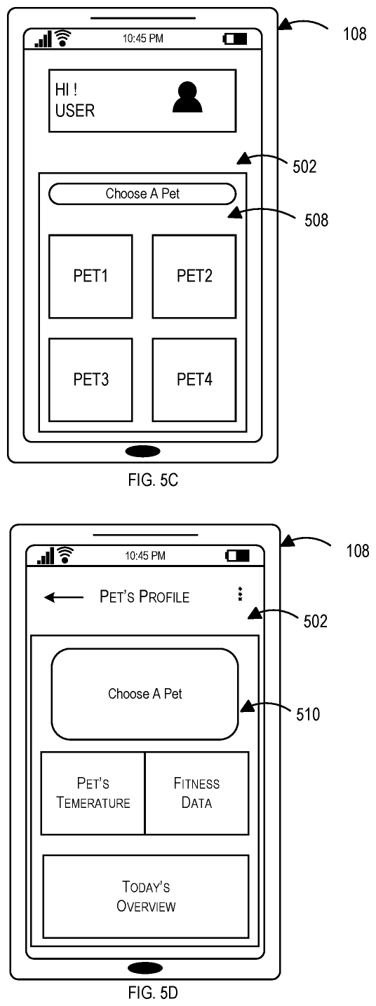

FIGS. 5A-5D illustrates one or more exemplary interfaces of the user device 108, in accordance with various embodiments of the present disclosure. For the sake of brevity of explanation, FIGS. 5A-5D have been explained together. In an embodiment of the present disclosure, as illustrated in FIG. 5A, the user may sign up or log in as shown by 504, to user device 108 by entering the user credential on an application 502. Such accessing via the user credential ensures that only authorized users can access the system 102, providing security and preventing unauthorized access. The sign-up page may facilitate new users to register for the module by providing their personal information and creating a username and password. In some embodiments, after creating the account, the user may register the details of the one or more pets in the application. In order to register, as shown in FIG. 5B, the user may enter general information 506, such as the pet's name, species of the pet, breed, date of birth, and/or gender. Such generation information 506 allows the application to determine the specific details associated with the diet and/or health of the one or more pets. Additionally, the application 502 may also facilitate the user to enter information associated with a medical condition or required medication of the pet for more personalized monitoring and feeding of the pet.

In order to monitor the one or more pets, the user may log in the application 502 that may display the one or more pet profiles associated with the one or more pets registered in the application 502, as shown by 508 in FIG. 5C. Each of the pet profiles may display data pertaining to the pet such as the pet's name, species, breed, date of birth, and gender, as well as data on the pet's activity level, feeding habits, and weight. The user may select a pet profile from the one or more pet profiles to monitor corresponding pet to monitor the pet's health and wellness data, as shown by 510 in FIG. 5D. The pet's health and wellness data may include the pet's temperature, fitness data, activity level, and overall health status. Further, the application 502 may utilize the AI model to generate a pet health report, which provides insights into the pet's physical and mental well-being. Further, the application 502 may also allow the user to share their pet's vital health parameters with the veterinarian Additionally, in case of an emergency such as the ones indicated high fever, low or high heart rate, or the like, the application may directly share the pet health status with the veterinary doctor by bypassing the user approval. Accordingly, such an application may facilitate the pet owner to interact with the pet feeder 106 and/or the pet collar 104 through the user device 108 remotely by providing real-time updates associated with the pet. Further, such applications may also display notifications, such as when the pet has been fed or when the pet is in close proximity to the pet feeder 106.

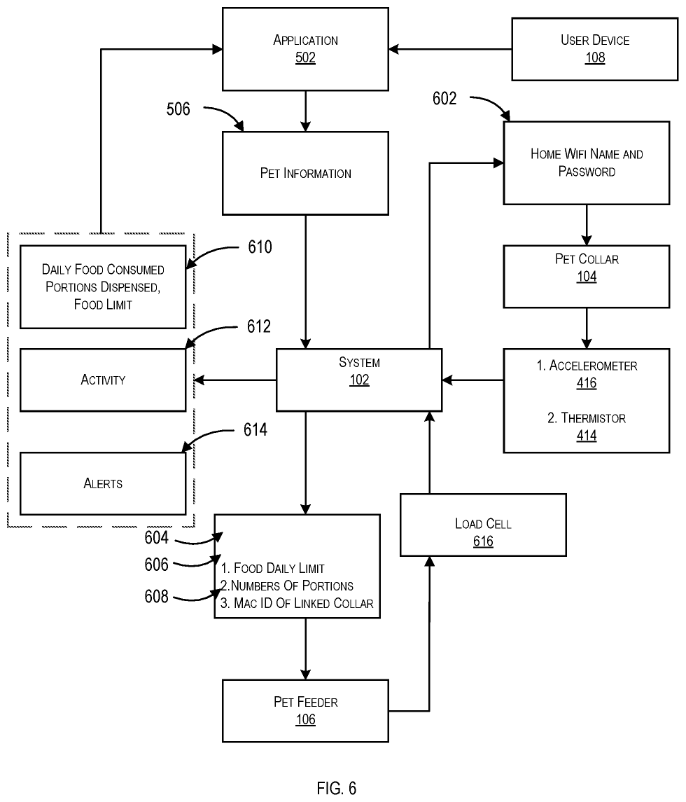

FIG. 6 illustrates an exemplary operation of the system for monitoring and feeding pets, in accordance with an embodiment of the present disclosure. In an embodiment of the present disclosure, the application 502 may be installed on the user device 108 and may have one or more pet information 506. Further, the application 502 may be connected to the system 102. Additionally, the system 102 may also be connected to the pet collar 104 and the pet feeder 106 via a wireless networking device such as Wi-Fi 602. In some embodiments, the pet collar 104 may monitor one or more activities associated with the pet via the accelerometer 416 and the body temperature of the pet via the thermistor 414. Such data may be provided to the system 102 that may calculate a physical state and the mental state of the pet based on the provided body temperature and the one or more activities, respectively. Such calculate physical state and the mental state may facilitate real-time monitoring of the pet, as elaborated in the previous paragraphs. In some embodiments, the pet feeder 106 connect to the system 102 may dispense the pet food to the pet based on the calculated amount of food and the food in the pet feeding container 318, as detected by the load cell 616. Such calculated amount of food may be based on the pre-stored data, such as food daily limit 604, number of portions 606, and Mac ID of the linked pet collar 608.

In some embodiments, the system 102 works in tandem with the pet feeder 106 and the pet collar 104 to form a report of the one or more pets in the establishment. The report of each of the one or more pets may include pet food details 610 such as daily food consumed, portions dispensed, and food limit for the pet, one or more activities of the pet 612, and the one or more alert 614 associated with the one or more pets in the establishment. The one or more alerts 614 may be generated based on the calculated physical state and the mental state of the one or more pets, as elaborate in previous paragraphs.

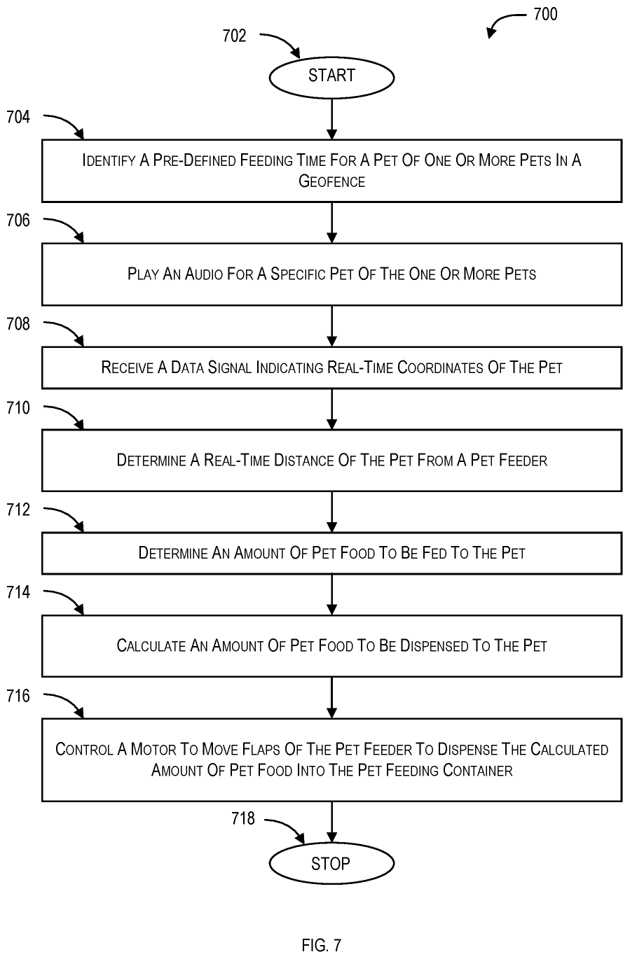

FIG. 7 illustrates a flow chart 700 of a method for monitoring and feeding pets, in accordance with an embodiment of the present disclosure. The method starts at step 702.

At first, a pre-defined feeding time for a pet of the one or more pets in a geofence may be identified, at step 704. The pre-defined feeding time may be automatically set by the AI model or manually set by a user. Upon identifying the pre-defined feeding time, an audio for a specific pet of the one or more pets may be played based on the identified feeding time, at step 706. It may be noted that each of the one or more pets in the establishment may be pre-trained to arrive for feeding in furtherance to playing a corresponding audio.

After playing the audio, a data signal indicating real-time coordinates of the pet may be received from a pet collar of the pet whose audio is played, at step 708. Based on the received data signal, a real-time distance of the pet from a pet feeder may be determined, at step 710. In order to determine the real-time distance of the pet, the method may include the steps of comparing the received real-time coordinates with the coordinates of the pet feeder.

Next, an amount of pet food to be fed to the pet may be determined by employing an Artificial Intelligence (AI) model, at step 712. Next, an amount of pet food to be dispensed to the pet may be calculated based on the determined amount of pet food and/or a current amount of pet food in a pet feeding container, at step 714. In some embodiments, the method may include the steps of calculating the current amount of pet food in the pet feeding container via a weight sensor to measure a weight of the pet food in the pet feeding container and/or a camera module to measure a volume of the pet food in the pet feeding container by employing an image processing technique.

Thereafter, a motor may be controlled to move one or more flaps of the pet feeder to dispense the calculated amount of pet food into the pet feeding container, at step 716. The pet food may be dispensed only when the determined real-time distance of the pet is less than a pre-defined threshold distance.

In some embodiments, the method may include the steps of sending a corresponding notification to the user when the pet collar is removed from the pet and the pet is out of the geofence. The method may also include the steps of measuring the body temperature of the pet and comparing the measured body temperature of the pet with a threshold temperature to determine a physical state of the pet associated with the pet having a high temperature. The method also includes the steps of sending a corresponding notification to a user and/or an assigned veterinarian based on the determined physical state of the pet.

In some embodiments, the method may include the steps of monitoring one or more activities of the pet and employing the AI model over the one or more activities to determine a mental state of the pet indicating that the pet is mentally unwell. The method also includes the steps of sending a corresponding notification to a user and/or an assigned veterinarian based on the determined mental state of the pet. In some embodiments, the method may include the steps of determining a potential therapy for the mental state of the pet and providing the determine potential therapy to the user in the sent notification. The method ends at step 718.

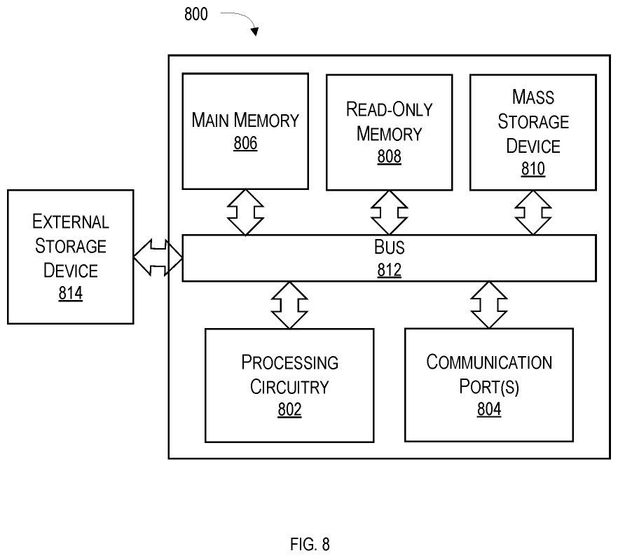

FIG. 8 illustrates an exemplary computer system in which or with which embodiment of the present disclosure may be utilized. As shown in FIG. 8, a computer system includes an external storage device 802, a bus 804, a main memory 806, a read-only memory 808, a mass storage device 810, a communication port 812, and a processor 814.

Those skilled in the art will appreciate that computer system 800 may include more than one processor 814 and communication ports 812. Examples of processor 814 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 814 may include various modules associated with embodiments of the present disclosure.

Communication port 812 can be any of an RS-232 port for use with a modem-based dialup connection, a 10/100 Ethernet port, a Gigabit or 10 Gigabit port using copper or fiber, a serial port, a parallel port, or other existing or future ports. Communication port 812 may be chosen depending on a network, such as a Local Area Network (LAN), Wide Area Network (WAN), or any network to which the computer system connects.

Memory 806 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 814.

Mass storage 810 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 804 communicatively couples processor(s) 814 with the other memory, storage, and communication blocks. Bus 804 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 814 to a software system.

Optionally, operator and administrative interfaces, e.g., a display, keyboard, and a cursor control device, may also be coupled to bus 804 to support direct operator interaction with the computer system. Other operator and administrative interfaces can be provided through network connections connected through communication port 812. An external storage device 802 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

What is claimed is:

1. A system for monitoring and feeding pets, the system comprises:
a timer module to identify a pre-defined feeding time for a pet of one or more pets in a geofence;
an audio module to play an audio for a specific pet of the one or more pets based on the identified feeding time, wherein each of the one or more pets is pre-trained to arrive for feeding in furtherance to playing a corresponding audio;
a receiving module to receive, from a pet collar of the pet whose audio is played, a data signal indicating real-time coordinates of the pet;
a proximity module to determine a real-time distance of the pet from a pet feeder based on the received data signal;
an analyzing module to:
determine an amount of pet food to be fed to the pet by employing an Artificial Intelligence (AI) model;
calculate an amount of pet food to be dispensed to the pet based on at least one of: the determined amount of pet food and a current amount of pet food in a pet feeding container; and
a dispensing module to control a motor to move one or more flaps of the pet feeder, when the determined real-time distance is less than a pre-defined threshold distance, to dispense the calculated amount of pet food into the pet feeding container.

2. The system as claimed in claim 1, wherein the pre-defined feeding time is at least one of: automatically set by the AI model and manually set by a user.

3. The system as claimed in claim 1, wherein the proximity module compares the received real-time coordinates with coordinates of the pet feeder to determine the real-time distance of the pet.

4. The system as claimed in claim 1, wherein the analyzing module calculates the current amount of pet food in the pet feeding container via at least one of: a weight sensor to measure a weight of the pet food in the pet feeding container, and a camera module to measure a volume of the pet food in the pet feeding container by employing an image processing technique.

5. The system as claimed in claim 1, wherein the pet feeder further comprises:
an overhead storage container to store the pet food, wherein the overhead storage container has one or more partitions to store one or more types of pet food associated with one or more pets; and
a funnel to direct a smooth flow of the pet food from the overhead storage container to the pet feeding container, wherein the funnel further comprises:
the motor to rotate based on a control signal from the dispensing module;
the one or more flaps coupled to the motor, such that the rotation of the motor moves the one or more flaps to control the flow of the pet food into the pet feeding container.

6. The system as claimed in claim 5, wherein the overhead storage container further comprises one or more lids for air-tight sealing of the one or more partitions via a slide lock mechanism controllable by a lid motor.

7. The system as claimed in claim 1, wherein the pet feeding container is movable across at least a vertical axis for height adjustment based on a height of the pet.

8. The system as claimed in claim 1, wherein the pet collar further comprises:
a housing that houses:
one or more sensors including at least one of: a thermistor to measure body temperature of the pet, an accelerometer to monitor one or more activities of the pet, and a Global Positioning System (GPS) to determine the real-time coordinates of the pet;
a microprocessor to calculate at least one of: physical state of the pet and a mental state of the pet based on the measured body temperature and monitored one or more activities of the pet, respectively;
a Global System for Mobile Communication (GSM) module to send a notification to at least one of: a user and an assigned veterinarian based at least on one of: the calculated physical state and the mental state of the pet;
a rechargeable power source to supply power to at least one of: the one or more sensors, the microcontroller, and the GSM module; and
a pair of straps that are each coupled to the housing and an electromechanical coupler at either end to secure the housing on the pet, wherein the pair of straps are made up of a breathable material.

9. The system as claimed in claim 8, wherein the electromechanical couplers are powered by the rechargeable power source, such that when the electromechanical couplers are uncoupled, an electrical signal is provided to the GSM module that sends a notification, indicating that the pet collar is removed, to the user if the pet is out of the geofence.

10. The system as claimed in claim 8, wherein the physical state is associated with a high temperature of the pet, wherein the microprocessor compares the measured body temperature of the pet with a threshold temperature to determine the high temperature associated with the pet.

11. The system as claimed in claim 8, wherein the mental state of the pet is associated with at least one of: anxiety, depression, loneliness, and anger, wherein the microprocessor employs the AI model over the one or more activities to determine if the pet is mentally unwell.

12. The system as claimed in claim 8, wherein the microprocessor further determines a potential therapy for the mental state of the pet and provides the determined potential therapy to the user in the sent notification.

13. A method for monitoring and feeding pets, the method comprises:
identifying a pre-defined feeding time for a pet of one or more pets in a geofence;
playing an audio for a specific pet of the one or more pets based on the identified feeding time, wherein each of the one or more pets is pre-trained to arrive for feeding in furtherance to playing a corresponding audio;
receiving, from a pet collar of the pet whose audio is played, a data signal indicating real-time coordinates of the pet;
determining a real-time distance of the pet from a pet feeder based on the received data signal;
determining an amount of pet food to be fed to the pet by employing an Artificial Intelligence (AI) model;
calculating an amount of pet food to be dispensed to the pet based on at least one of: the determined amount of pet food and a current amount of pet food in a pet feeding container; and
controlling a motor to move one or more flaps of the pet feeder, when the determined real-time distance is less than a pre-defined threshold distance, to dispense the calculated amount of pet food into the pet feeding container.

14. The method as claimed in claim 13, wherein the pre-defined feeding time is at least one of: automatically set by the AI model and manually set by a user.

15. The method as claimed in claim 13, further comprises comparing the received real-time coordinates with coordinates of the pet feeder to determine the real-time distance of the pet.

16. The method as claimed in claim 13, further comprises calculating the current amount of pet food in the pet feeding container via at least one of: a weight sensor to measure a weight of the pet food in the pet feeding container and a camera module to measure a volume of the pet food in the pet feeding container by employing an image processing technique.

17. The method as claimed in claim 13, further comprises sending a corresponding notification to the user when the pet collar is removed from the pet and the pet is out of the geofence.

18. The method as claimed in claim 13, further comprises:
measuring a body temperature of the pet;
comparing the measured body temperature of the pet with a threshold temperature to determine a physical state of the pet associated with the pet having a high temperature; and
sending, based on the determined physical state of the pet, a corresponding notification to at least one of: a user and an assigned veterinarian.

19. The method as claimed in claim 13, further comprises:
monitoring one or more activities of the pet;
employing the AI model over the one or more activities to determine a mental state of the pet indicating that the pet is mentally unwell; and
sending, based on the determined mental state of the pet, a corresponding notification to at least one of: a user and an assigned veterinarian.

20. The method as claimed in claim 19, further comprises:
determining a potential therapy for the mental state of the pet; and
providing the determine potential therapy to the user in the sent notification.
